(19) United States
(12) Patent Application Publication
(10) Pub. No.: US 2025/0019267 A1
(43) Pub. Date: Jan. 16, 2025

(54) High Efficiency UV LED Reactor for Flow Treatment and Sterilization of Fluids

(71) Applicant: TSLC CORPORATION, CHU-NAN (TW)

(72) Inventors: PO-WEI LEE, HSINCHU COUNTY (TW); SHENG-HO LIU, MIAOLI COUNTY (TW); YU-JU CHEN, CHANGHUA CITY (TW); YEN-CHAO LIN, TAOYUAN CITY (TW)

(73) Assignee: TSLC CORPORATION, CHU-NAN (TW)

(21) Appl. No.: 18/766,758

(22) Filed: Jul. 9, 2024

Related U.S. Application Data
(60) Provisional application No. 63/526,257, filed on Jul. 12, 2023.

(51) Int. Cl. C02F 1/32

(52) U.S. Cl. CPC C02F 1/325; C02F 2209/02; C02F 2303/04

(57) ABSTRACT

A UV LED reactor includes a housing having an inlet, an outlet and a reactor chamber; a UV LED module mounted to the housing configured to emit UV radiation into the reactor chamber having a selected wavelength range and with a selected energy (E); and a heatsink on the UV LED module configured to dissipate heat generated by the UV LED module. The heatsink on the UV LED module includes one or more surfaces in thermal communication or physical contact with the fluid, which improves the efficiency of heat transfer from the heatsink to the fluid and eliminates the need for cooling fans. The UV LED reactor can also include a UV transparent inner tube mounted to the inlet for generating a double UV exposure flow path through the reactor chamber. The UV LED reactor can also include a UV reflective coating on the sidewalls of the housing, or on a separate tube or sleeve mounted to the housing, configured to reflect UV radiation onto the fluid in the reactor chamber.

### CROSS REFERENCE TO RELATED APPLICATION

This application claims priority from U.S. Provisional No. 63/526,257, filed Jul. 12, 2023, which is incorporated herein by reference.

### FIELD

This application relates to fluid treatment reactors and particularly to UV LED reactors for flow treatment and sterilization of fluids, such as water.

### BACKGROUND

Water Treatment: UV reactors are widely used in water treatment processes to disinfect water by inactivating harmful microorganisms, such as bacteria, viruses and protozoa. The UV radiation damages the DNA or RNA of these microorganisms, rendering them unable to reproduce and cause diseases.

Air Purification: UV reactors can be employed in air purification systems to eliminate airborne pathogens, bacteria and viruses. The UV radiation disrupts the genetic material of these microorganisms, preventing their reproduction and spread.

Chemical Reactions: UV reactors are utilized in certain chemical reactions that require UV light as a catalyst.

Referring to FIGS. 1A and 1B, a prior art Type 1 UVC reactor 10 for treating water with UV radiation 14 is illustrated. The UV reactor 10 includes at least one UV tube lamp 12 having at least one UV source 18 (FIG. 1B), such as a low-pressure mercury vapor lamp, configured to emit the UV radiation 14 in a desired wavelength, such as UVC. The UV tube lamp 12 also includes a quartz sleeve 16 (FIG. 1B), configured to allow the UV radiation 14 to pass through, while protecting the UV source 18 (FIG. 1B). A reactor chamber 20 contains the UV tube lamp 12 and provides a controlled environment for the water, or other target material, or medium, to be exposed to the UV radiation 14. The reactor chamber 20 includes a water inlet 22 and a water outlet 24 in flow communication with water hoses 32, 34 in flow communication with a water source (not shown). The water flow path 26 is denoted by the flow arrow. The UVC reactor 10 also includes a power supply 30, such as a AC power supply. The control system 28 provides on/off functions and timing and can also include a controller, a heatsink and a PCB board (not shown).

Referring to FIG. 2, a prior art Type 2 UVC reactor 36 includes a housing 48 having a UV LED module 38 mounted therein, which is housed in a quartz glass tube 40, having a water inlet 42 and a water outlet 44 for providing a water flow path 46. The water inlet 42 and the water outlet 44 are in flow communication with water hoses 50, 52 in flow communication with a water source (not shown). The Type 2 UVC reactor 36 also includes a cooling fan 54 and a power supply 56. In the prior art Type 2 UVC reactor 36, the cooling fan 54 takes up space and is expensive to operate and maintain.

The present disclosure is directed to a high efficiency UV LED reactor having improved operations characteristics over the prior art UVC reactors including a heatsink in place of a cooling fan to save cost and space, a UV reflective coating covering a UV transparent outer tube for improving performance, and a UV transparent inner tube configured to direct fluid flow for improving performance.

### SUMMARY

A first embodiment UV LED reactor for performing a treatment process on a fluid includes a housing having a reactor chamber, a fluid inlet and a fluid outlet; at least one UV LED module mounted to the housing configured to emit UV radiation in a selected wavelength range (e.g., 180 nm to 430 nm) and with a selected energy (E); and a heatsink on the UV LED module configured to dissipate heat generated by the UV LED module. The heatsink includes one or more surfaces in contact with the fluid, which improves the efficiency of heat transfer from the heatsink to the fluid. The UV LED module also includes a UV transparent window mounted to the heatsink configured to provide a planar emitting surface for the UV LED emitter to emit the UV radiation into a radiation target area of the reactor chamber.

The UV LED reactor can also include a UV transparent inner tube mounted to the fluid inlet of the housing in flow communication with the fluid inlet and the fluid outlet on the housing. The function of the UV transparent inner tube is to direct fluid flow in a first direction towards the UV LED module and then in a second direction away from the UV LED module. Both the first direction and the second direction are generally parallel to the longitudinal axis of the reactor chamber and are termed herein “double UV exposure flow path”. Since the fluid has at least two distinct linear flow paths, through the reactor chamber, the exposure time (t) is at least double the exposure time (t) for the prior art UV LED reactor, assuming a same fluid flow rate.

A second embodiment UV LED reactor has the configuration of a heat exchanger. The heat exchanger UV LED reactor includes a cylindrical housing having open ends with UV LED modules mounted on each end. Each LED module includes a plurality of LED emitters on a PCB board and a heatsink in thermal communication with the LED emitters. The heatsinks are also in thermal communication with fluid flowing within the housing. The housing includes a fluid inlet and a fluid outlet configured to circulate the fluid close to the heatsinks on the LED modules at both ends of the housing.

A third embodiment UV LED reactor includes a UV transparent tube mounted to the inner sidewalls of the housing in proximity to the UV LED module having a UV reflective coating covering an inside or outside surface thereof. In addition to being exposed to direct UV radiation from the UV LED module, the fluid in the reactor chamber is also exposed to reflected UV radiation along an entire length of the UV transparent tube, which has been reflected from the reflective coating on the UV transparent tube back into the reactor chamber.

A fourth embodiment UV LED reactor includes both a UV transparent tube mounted to the housing having a UV reflective coating thereon, and a UV transparent inner tube mounted to the fluid inlet on the housing within the UV transparent tube. The UV transparent inner tube, in addition to initiating the previously described “double UV exposure flow path”, can also be configured to initiate a “vortex flow path”. The vortex flow path travels from the fluid inlet and around and circumjacent to the UV transparent inner tube, where it combines with the “double UV exposure flow path”. The UV transparent inner tube is formed with an inside diameter “r” that determines the geometry of the vortex flow path.

In each of the embodiments of the UV LED reactors, the UV LED modules can include LED emitters configured to emit UV radiation with a narrow beam angle, a wide beam angle or anything in between. The beam angles can be symmetrical to the longitudinal axis of the reactor chamber and can be selected to extend into the reactor chamber by a selected penetrating distance (D). Different methods for manipulating the shape and penetrating distance (D) of the UV radiation emitted by LED emitters include: a wide light beam formed using a packaged LED die and UV transparent window, a narrow light beam formed using a packaged LED die and an optical lens, a narrow light beam formed using a packaged LED die and a collimated optical lens, a narrow light beam formed using a packaged LED die, a UV transparent window and a reflector.

Each of the embodiments of the UV LED reactors (Embodiments 1-4), can also include one or more sensors integrated into the housing, the UV LED modules and the heatsinks. For example, temperature sensors can be integrated into the UV LED modules to detect high temperatures and shut off the LED emitters. Other sensors can be configured to sense: water quality, UV intensity, flow properties, as well as any desired parameters. In addition, a PCB board of the UV LED module can be configured to receive input from the sensors and control other components such as a pump.

### BRIEF DESCRIPTION OF THE DRAWINGS

Exemplary embodiments are illustrated in the referenced figures of the drawings. It is intended that the embodiments and the figures disclosed herein be considered illustrative rather than limiting.

FIG. 1A is a schematic cross-sectional view illustrating a prior art Type 1 UVC reactor;

FIG. 1B is a schematic cross-sectional view illustrating a prior art UV tube lamp of the Type 1 UVC reactor;

FIG. 2 is a schematic cross-sectional view illustrating a prior art Type 2 UVC reactor;

FIG. 3 is a schematic cross-sectional view illustrating a first embodiment UV LED reactor configured to perform a treatment process on a fluid;

FIG. 4 is a schematic cross-sectional view illustrating features of a UV LED module of the first embodiment UV LED reactor including a heatsink configured to increase heat transfer to the fluid;

FIGS. 5A, 5B and 5C are schematic cross-sectional views illustrating features of a housing and different heatsinks of the first embodiment UV LED reactor configured to increase heat transfer to the fluid;

FIG. 6 is a schematic cross-sectional views illustrating features of the UV LED module of the first embodiment UV LED reactor configured to increase heat transfer to the fluid;

FIG. 7A is an exploded schematic perspective view of a second embodiment UV LED reactor having the configuration of a heat exchanger;

FIG. 7B is a schematic cross-sectional view of the second embodiment UV LED reactor;

FIG. 7C is an exploded schematic perspective view of the second embodiment UV LED reactor;

FIG. 8 is a schematic cross sectional view of sensor circuitry for the first embodiment UV LED reactor;

FIG. 9 is a schematic cross-sectional view illustrating a third embodiment UV LED reactor;

FIG. 10 is a schematic cross-sectional view illustrating a fourth embodiment UV LED reactor;

FIG. 11A is a schematic cross-sectional view illustrating a vortex flow path for the fourth embodiment UV LED reactor;

FIG. 11B is a schematic cross-sectional view taken along section line 11B-11B of FIG. 11A illustrating the vortex flow path for the fourth embodiment UV LED reactor;

FIG. 12A is a schematic cross-sectional view illustrating a fifth embodiment UV LED reactor wherein a UV LED module includes a sealed glass window;

FIG. 12B is an enlarged schematic cross-sectional view illustrating the sealed glass window of the UV LED module for the fifth embodiment UV LED reactor;

FIG. 12C is an enlarged schematic cross-sectional view illustrating preferred operational characteristics of the sealed glass window of the UV LED module for the fifth embodiment UV LED reactor;

FIG. 13A is an enlarged schematic cross-sectional view illustrating UV radiation emitted by the UV LED module for the fifth embodiment UV LED reactor in the form of a wide light beam formed using a packaged LED die and UV transparent window;

FIG. 13B is an enlarged schematic cross-sectional view illustrating UV radiation emitted by the UV LED module for the fifth embodiment UV LED reactor in the form of a narrow light beam formed using a packaged LED die and an optical lens;

FIG. 13C is an enlarged schematic cross-sectional view illustrating UV radiation emitted by the UV LED module for the fifth embodiment UV LED reactor in the form of a narrow light beam formed using a packaged LED die and a collimated optical lens;

FIG. 13D is an enlarged schematic cross-sectional view illustrating UV radiation emitted by the UV LED module for the fifth embodiment UV LED reactor in the form of a narrow light beam formed using a packaged LED die, a UV transparent window and a reflector;

FIG. 14 is an enlarged schematic cross-sectional view illustrating a sixth embodiment UV LED reactor having a housing with a reactor chamber formed with a UV reflective coating thereon;

FIG. 15A is an enlarged schematic cross-sectional view illustrating the sixth embodiment UV LED reactor with a pump;

FIG. 15B is an enlarged schematic cross-sectional view illustrating the sixth embodiment UV LED reactor with one or more sensors;

FIG. 16A is an enlarged schematic cross-sectional view illustrating the sixth embodiment UV LED reactor with a filter mounted to a UV transparent inner tube;

FIG. 16B is an enlarged schematic cross-sectional view illustrating the sixth embodiment UV LED reactor with an externally mounted filter;

FIG. 17 is an enlarged schematic cross-sectional view illustrating a seventh embodiment UV LED reactor having multiple LED modules and multiple UV transparent inner tubes configured to generate multiple vortex fluid flows;

FIGS. 18A-18G are different views of the housing of the fourth embodiment UV LED reactor including: a schematic cross-sectional view (FIG. 18A), a schematic side elevation view (FIG. 18B), a schematic exploded view (FIG. 18C), a schematic perspective view (FIG. 18D), a schematic end view (FIG. 18E), a schematic side elevation view (FIG. 18F) and a schematic end view (FIG. 18G);

FIG. 19A is a schematic exploded perspective view with parts removed of the fourth embodiment UV LED reactor; and

FIG. 19B is a schematic exploded perspective view with parts removed of the fourth embodiment UV LED reactor.

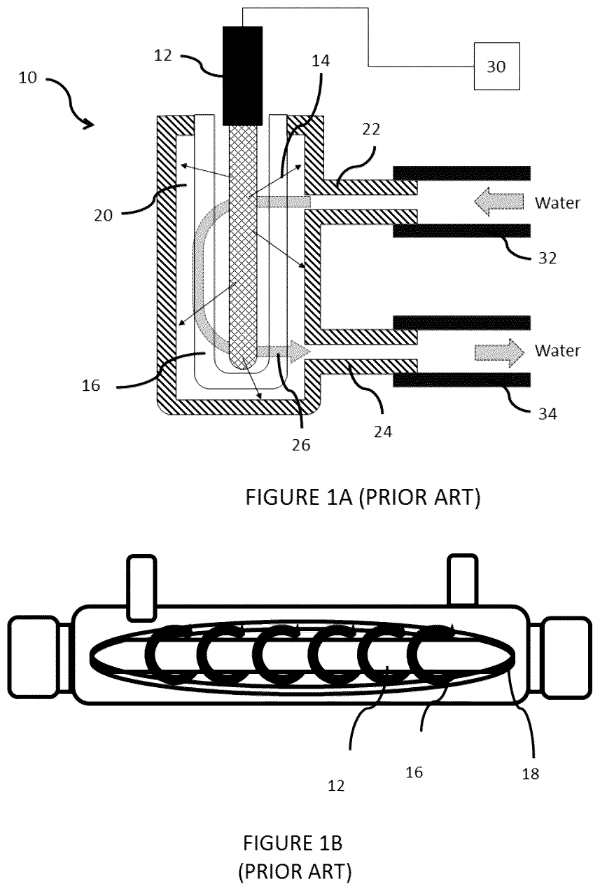

### DETAILED DESCRIPTION

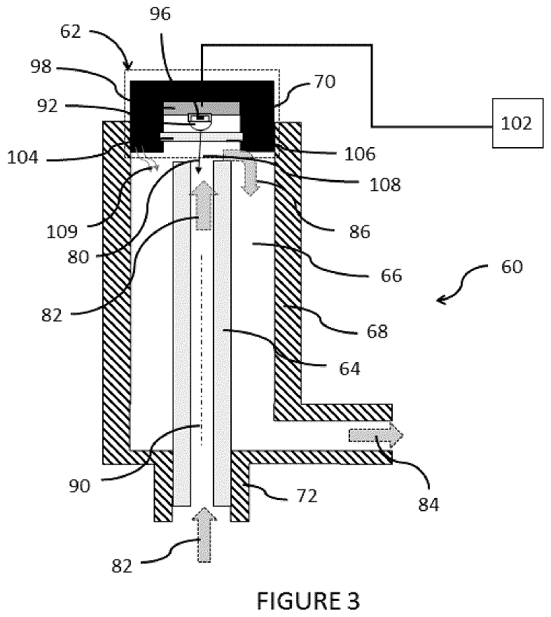

Referring to FIG. 3, a first embodiment UV LED reactor 60 is configured to perform a treatment process, in the form of sterilization process, on a fluid, in the form of water 82. The UV LED reactor 60 includes a housing 68, at least one UV LED module 62 mounted to the housing 68 configured to emit UV radiation 80, a UV transparent inner tube 64 mounted to the housing 68 in proximity to the UV LED module 62, a reactor chamber 66 in the housing 68 configured to expose the water 82 to the UV radiation 80, and a heatsink 70 on the UV LED module 62 configured to dissipate heat generated by the UV LED module 62.

As shown in FIG. 3, the housing 68 includes a water inlet 72 which is in flow communication with a source of the water 82. The housing 68 also includes a water outlet 74 configured to discharge treated water 84 from the reactor chamber 66 in flow communication with a treated water system, such as a storage tank (not shown) or treated water supply system (not shown). The housing 68 can comprise a UV resistant material, such as a metal, a polymer or a composite material having a desired geometrical configuration. For example, the housing 68 can comprise a cylindrical vessel with a hollow interior configured to form the reactor chamber 66 with an elongated shape and a longitudinal axis 90 extending from the top to the bottom of the housing 68. The housing 68 can be formed using a suitable process, such as machining, molding, casting or 3-D printing.

Still referring to FIG. 3, the housing 68 is also configured to direct the water 82 through a water flow path 86 from the water inlet 72 into the reactor chamber 66, wherein the water 82 is exposed to UV radiation 80 emitted by the UV LED module 62, and then to the water outlet 74 for discharge as treated water 84. In the illustrative embodiment, the water flow path 86 through the reactor chamber 66 has several flow vectors. As the water flow path 86 enters the reactor chamber 66, the water flows under pressure from the water inlet 72 into a UV radiation target area 108 in close proximity to a UV emitting surface 106 of the UV LED module 62 and initially generally parallel to the UV emitting surface 106 of the UV LED module 62. The water flow path 86 then makes a 90 degree turn and flows orthogonally (perpendicular) with respect to the emitting surface 106 of the UV LED module 62 and generally parallel to the longitudinal axis 90 of the reactor chamber 66. The water flow path 86 than makes another 90 degree turn with respect to the longitudinal axis 90 and discharges from the reactor chamber 66 into the water outlet 74.

Still referring to FIG. 3, the UV LED module 62 can be configured to emit UV radiation 80 having a selected wavelength range and energy (E) depending on the treatment process. A representative wavelength range can be from 180 nm to 430 nm. For a sterilization process, studies have shown that a UVC wavelength of 230 nm to 280 nm is effective against all foodborne pathogens, natural microbiota, molds and yeasts. Because microorganisms come with different sizes and shapes that affect their UV absorption, the required exposure time (t) for killing each species varies. UV sterilization also known as UV disinfection or ultraviolet germicidal irradiation (UVGI) works by breaking down certain chemical bonds and scrambling the structure of DNA, RNA and proteins, causing a microorganism to be unable to multiply. When a microorganism is unable to multiply, it is considered dead since it cannot reproduce with a host and is no longer infectious. Since UV sterilization uses the energy of UVC to destroy bio molecules, its effectiveness depends on the total energy (E) applied, which is affected by the length of exposure time (t) and the distance from the UV LED emitters 96. Depending on the treatment process, the exposure time (t) can be achieved by selection of the length (L) of the reactor chamber 66 and the flow rate of the water flow path 86 through the reactor chamber 66. The required total energy (E) can be achieved by selection of the power of the UV LED module 62.

Still referring to FIG. 3, the UV LED module 62 can include a base 98 mounted to the housing 68, and one or more LED emitters 96 mounted in a cavity on the base 98. The LED emitters 96 can comprise packaged or unpackaged LED dice formed using conventional semiconductor fabrication techniques and configured to emit UV radiation having a desired wavelength. Depending on the treatment process, a representative wavelength range can be from 180 nm to 430 nm. The UV LED module 62 also includes optics 92 such as a lens for the LED emitters 96, and a power supply 102. The base 98 can include an integral PCB board having other electrical components as required, such as a controller and other circuitry as required. The UV LED module 62 also includes a UV transparent window 104 mounted to the heatsink 70 configured to seal the LED emitters 96 from the water 82. In addition, the UV transparent window 104 forms a planar emitting surface 106 wherein the UV radiation 80 emitted by the LED emitters 96 emits from the UV LED module 62 into the UV radiation target area 108. In the UV LED module 62, the UV radiation target area 108 is the area in the reactor chamber 66 just below the planar emitting surface 106 extending into the reactor chamber by a distance (d) that is less than the length (L) of the reactor chamber 66. Both the distance (d) and the length (L) can be measured in centimeters. The UV transparent window 104 can comprise a UV transparent material, such as quartz glass or a transparent polymer, and can also include sealants and o-rings configured to perform sealing functions. Preferably, the UV LED module 62 is removable from the housing 68 as a replaceable component. This allows different wave lengths of UV to be used by the UV LED reactor 60 for performing different treatment processes.

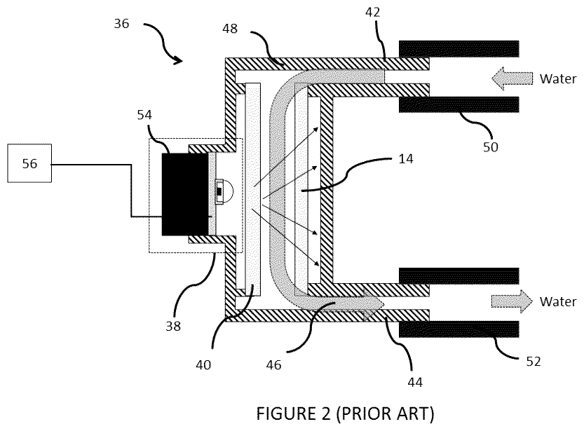

Still referring to FIG. 3, the heatsink 70 has at least one surface configured to dissipate heat 109 generated by the UV LED module 62 into the water 82 flowing within the reactor chamber 66. During operation, the LED emitters 96 generate large amounts of heat 109, which can lead to degradation and poor performance due to high temperatures. Therefore a cooling system is necessary to dissipate the heat 109. In the prior art, cooling fans 54 (FIG. 2) are typically used to dissipate the heat 109, which requires extra cost, space and power. In the UV LED module 62, the heatsink 70 is in contact with the housing 68, and also includes one or more surfaces in contact with the water 82 flowing within the reactor chamber 66. This arrangement effectively removes the heat 109 from the LED emitters 96 without the need for an additional cooling fan. The heatsink 70 can comprise a material having a high thermal conductivity, such as metal, a heat-dissipating plastic or a ceramic. A thermal conductivity coefficient of the heatsink is preferably more than 20 W/mK. In addition, the heatsink 70 preferably comprises a single piece of material with a continuous surface in contact with the water 82 flowing within the reactor chamber 66 to provide efficient cooling performance. The materials for the heatsink 70 can be selected to ensure efficient heat transfer and to maintain the LED emitters 96 at an optimal operating temperature, thereby enhancing performance and longevity.

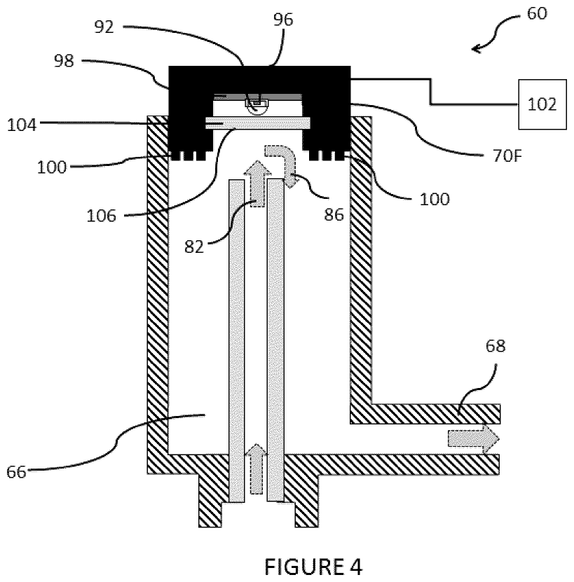

Referring to FIG. 4, a heatsink 70F includes cooling fins 100 configured to provide an increased surface area for heat exchange from the heatsink 70F to the water 82. In addition, the heatsink 70F can have a shape such as the horseshoe shape shown in FIG. 4, wherein the cooling fins 100 have a large area in contact with the water 82. The heatsink 70F can comprise a unitary structure or an assembly of several interconnected parts to enhance structural integrity and thermal performance. Still further, surfaces of the heatsink 70F, and of the of the cooling fins 100 as well, can be treated to increase surface area with features such as grooves, or ridges, which allow for more effective heat exchange from the heatsink 70F to the water 82. In addition, the heatsink 70F can include coatings and materials, such as metal, polymers, and ceramics, having heat transfer characteristics configured to improve thermal conductivity paths and also to increase surface area and enhance heat dissipation. These design considerations ensure that the heatsink 70F effectively manages the thermal load of the LED emitters 96, maintaining their performance and extending their lifespan, without the requirement of a cooling fan.

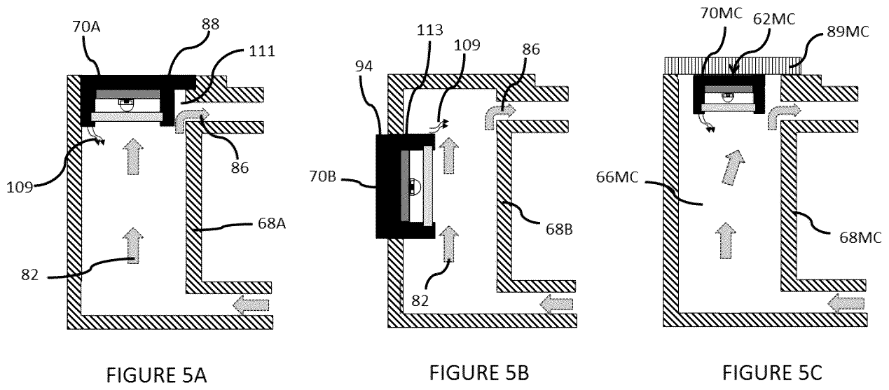

Referring to FIG. 5A, FIG. 5B and FIG. 5C, a housing 68A (FIG. 5A) and a housing 68B (FIG. 5B) are designed with various geometries and features configured to efficiently transfer heat to the water 82, where it is dissipated and removed from the reactor chamber 66 by the water flow 86. In FIG. 5A, the housing 68A includes one or more cooling passageways 111 that direct water flow 86 around a heatsink 70A. In addition, the heatsink 70A (FIG. 5A) includes an L-shaped cooling segment 88 that directs the water flow 86 through the cooling passageways 111 and provides a large surface area for heat transfer. In FIG. 5B, the housing 68B is shaped to direct water flow 86 generally parallel to a heatsink 70B having a large bulky shape relative to the housing 68B (e.g., >50% of a side of the housing 68B) with a T-shaped cooling segment 94 configured to dissipate heat to the atmosphere. The heatsink 70B also includes cooling walls 113 that extend into the reactor chamber 66 and provide a large surface area for heat transfer to the water 82. In FIG. 5C, the UV LED module 62MC includes a heatsink 70MC mounted to a mechanical connector 89MC configured to mount the UV LED module 62MC to a housing 68MC with the heatsink 70MC within the reactor chamber 66MC.

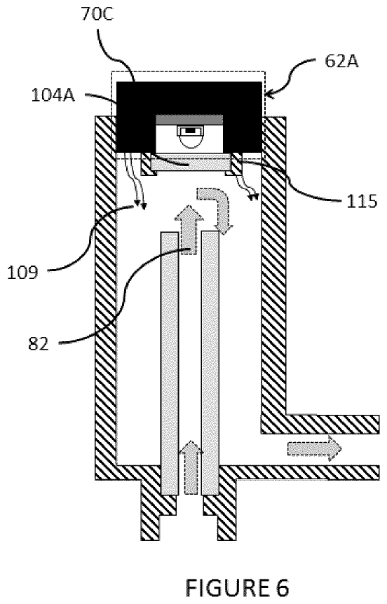

Referring to FIG. 6, a UV LED module 62A includes additional features configured to improve heat transfer to the water 82. The UV LED module 62A includes a thermally conductive holder 115 for mounting a UV transparent window 104A to a heatsink 70C. The thermally conductive holder 115 is in physical contact with the heatsink 70C providing a medium to transfer heat from the UV LED module 62A to the water 82 thus helping to reduce the temperature of the UV LED module 62A. The thermally conductive holder 115 can comprise a material having a high thermal conductivity, such as metal, heat dissipating plastic or ceramic. These materials are selected to ensure efficient heat transfer, enhancing the cooling process. By incorporating these thermally conductive materials, the thermally conductive holder 115 not only secures the UV transparent window 104A but also plays a crucial role in maintaining an optimal operating temperature of the UV LED module 62A, thereby improving its performance and longevity.

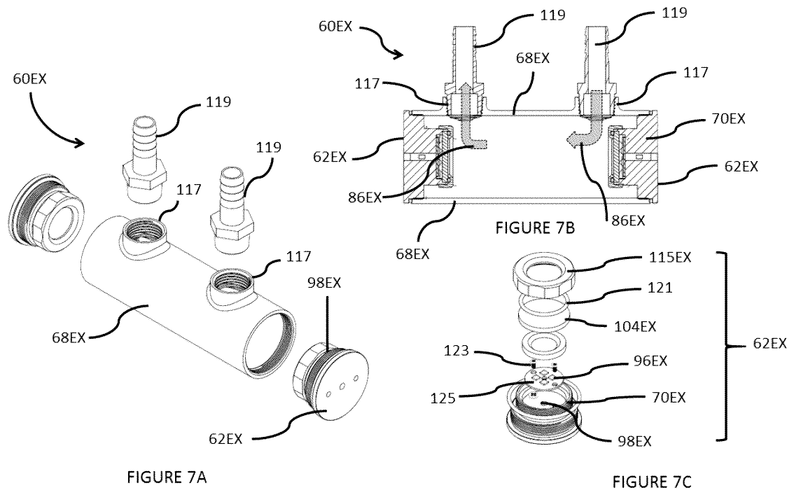

Referring to FIGS. 7A-7C, a second embodiment heat exchanger LED reactor 60EX includes a housing 68EX comprising a cylindrical tube having threaded open ends, and UV LED modules 62EX having heatsinks 70EX mounted to each end. In addition, each UV LED module 62EX includes a male threaded base 98EX configured to threadably attach to female threads on the housing 68EX. As shown in FIGS. 7A and 7B, the housing 68EX includes threaded nipples 117 for receiving threaded hose adaptors 119 that form an inlet (right adaptor 119 in FIG. 7B) and an outlet (left adaptor 119 in FIG. 7B) on the housing 68EX. As shown in FIG. 7C, the UV LED module 62EX also includes a UV transparent window 104EX secured by a thermally conductive holder 115EX, a scaling O-ring 121, a plurality of LED emitters 96EX on a PCB board 125, and threaded fasteners 123 configured to attach the PCB board 125 to the heatsink 70EX. As shown in FIG. 7B, the water flow path 86EX in the heat exchanger LED reactor 60EX is directed in proximity to the heatsinks 70EX at both ends of the housing 68EX such that heat is efficiently dissipated into the water.

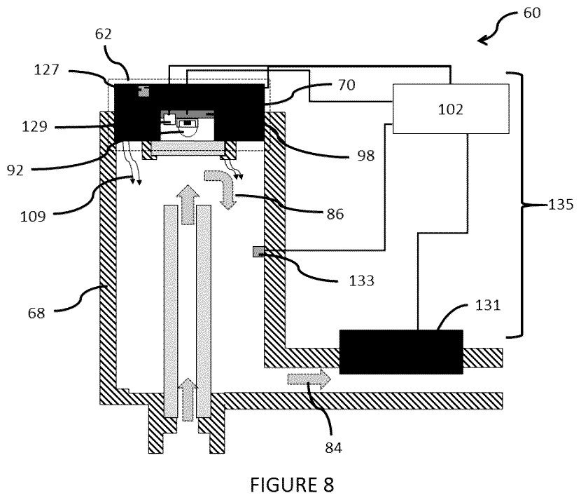

Referring to FIG. 8, the UV LED reactor 60 (or the heat exchanger LED reactor 60EX) can also include a sensor circuitry 135 integrated into the housing 68, into the UV LED module 62 and into the power supply 102. The sensor circuitry 135 can include a temperature sensor 127 on the heatsink 70 and a switch 129 on the base 98 of the UV LED module 62. In the UV LED reactor 60, heat 109 is dissipated by the water flow path 86. If there is no flow, the heat 109 cannot be removed, which can lead to an increase in temperature of the LED emitters 96 causing issues such as reduced efficiency, shortened lifespan, and permanent damage to circuit components. To mitigate the effect of excess heat, the temperature sensor 127 can be mounted to the heatsink 70 (or to the base 98) to detect high temperatures. When a high temperature is detected, the temperature sensor 127 signals the switch 129 to switch off, or reduce the power of the LED emitters 92. A flow sensor/switch 131 can provide an additional layer of protection by alerting the system if water flow volume is inadequate, thereby preventing potential overheating problems. One or more sensors 133 can also be integrated into the housing 60 to sense various operational parameters. For example, the sensors 133 can be configured to sense: water quality, UV intensity, flow properties, as well as any desired parameters. In addition, the power supply 102 can be configured to receive input from the sensors 133 and control other components of the sensor circuitry 135.

Referring to FIG. 9, a third embodiment reflective UV LED reactor 60R includes a housing 68R and a UV LED module 62R constructed substantially as previously described for housing 68 (FIG. 3) and UV LED module 62 (FIG. 3). In addition, the housing 68R includes an inlet 72R and an outlet 74R configured to provide a water flow path 86R. The UV LED reactor 60R also includes a UV transparent tube 137 mounted to the inner sidewalls of the housing 68R in proximity to the UV LED module 62R and along the length of the housing 68R. The UV transparent tube 137 includes a UV reflective coating 139 covering an inside or outside surface thereof. In addition to being exposed to direct UV radiation 80 from the UV LED module 62R, the water in the reactor chamber 66R is also exposed to reflected UV radiation 142 along the entire length of the UV transparent tube 137, which has been reflected from the reflective coating 139 on the UV transparent tube 137 back into the reactor chamber 66R.

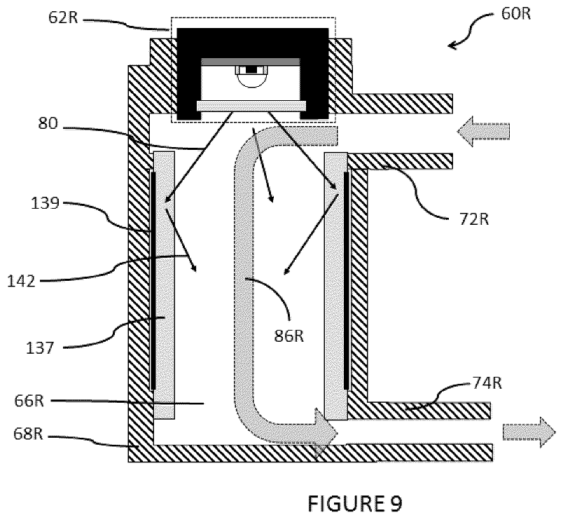

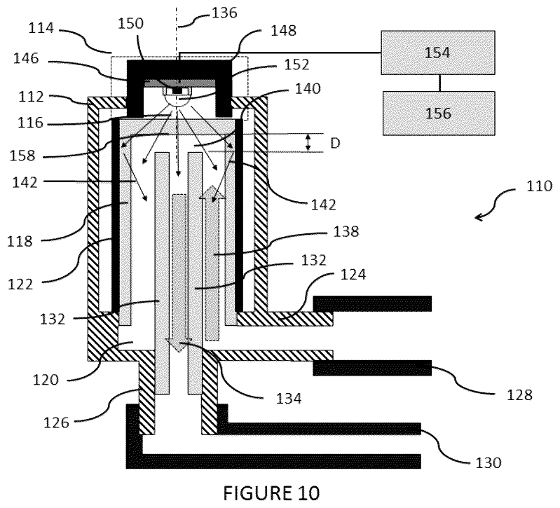

Referring to FIG. 10, a fourth embodiment UV LED reactor 110 is also configured to perform a water sterilization treatment process. The UV LED reactor 110 includes a housing 112, at least one UV LED module 114 mounted to the housing 112 configured to emit UV radiation 116 having a selected wavelength range and energy (E) depending on the treatment process, a UV transparent outer tube 118 (or sleeve) mounted to the housing 112 in close proximity to the UV LED module 114, a reactor chamber 120 configured to expose the water to the UV radiation 116, and a UV reflective coating 122 covering an outside or inside surface of the UV transparent outer tube 118. In the second embodiment UV LED reactor 110, the UV transparent outer tube 118 is closed on one end and can be configured to provide a planar UV transparent window on the closed end that seals against the UV LED module 114. In other embodiments, a separate transparent window can be provided. In addition, the UV transparent outer tube 118 is open on an opposing end to allow water to flow in different directions through the reactor chamber 120.

As shown in FIG. 10, the UV LED module 114 also includes a base 146 mounted to the housing 112, and one or more LED emitters 150 mounted in a cavity on the base 146. The UV LED module 114 also includes a heatsink 148 on the base 146, optics 152, such as a lens for the LED emitters 150, and a PCB board 154 in electrical communication with a power supply 156. The PCB board 154 can comprise a stand-alone component or can be incorporated into the base 146 of the UV LED module 114. In addition, the PCB board 154 can include other electrical components as required, such as a controller and other circuitry as required. In the UV LED module 114, the UV radiation target area 140 is the area in the reactor chamber 120 just below a planar emitting surface 158 formed by the closed end of the UV transparent inner tube 132. The UV radiation target area 140 extends into the reactor chamber 120 by a distance (d) (FIG. 5B) that is less than the length (L) of the reactor chamber 120. Also in this embodiment, the heatsink 148 does not include a surface in thermal contact with the water.

As shown in FIG. 10, the housing 112 includes a water inlet 124 connected to an inlet water hose 128, which is in flow communication with a source of untreated water 82 (FIG. 3). The housing 68 also includes a water outlet 126 configured to discharge treated water 84 (FIG. 3) from the reactor chamber 120 to an outlet water hose 130 in flow communication with a treated water system, such as a storage tank (not shown) or treated water system (not shown)

Still referring to FIG. 10, the fourth embodiment UV LED reactor 110 also includes a UV transparent inner tube 132 (or sleeve) mounted in the reactor chamber 120 within the UV transparent outer tube 118. The purpose of the UV transparent inner tube 132 is to direct water flow in a first direction of water flow 138 towards the UV LED module 114 and then in a second direction of water flow 134 away from the UV LED module 114. Both the first direction of water flow 138 and the second direction of water flow 134 are generally parallel to the longitudinal axis of the reactor chamber 120. The UV transparent inner tube 132 can be sealingly attached to the water outlet 126 of the housing substantially as shown in FIG. 4. The UV transparent inner tube 132 can comprise quartz glass or any material having a UV transmitting rate over 80%. In addition, the UV transparent inner tube 132, and the UV transparent outer tube 118 as well, can have a desired geometrical configuration, such as a cylindrical, square, or rectangular tube-shape, which is open on both ends in the case of the UV transparent inner tube 132 (FIG. 4), and closed on one end in the case of the UV transparent outer tube 118 (FIG. 3). Both the UV transparent inner tube 132 (FIG. 4) and the UV transparent outer tube 118 (FIG. 4) are removeable for servicing.

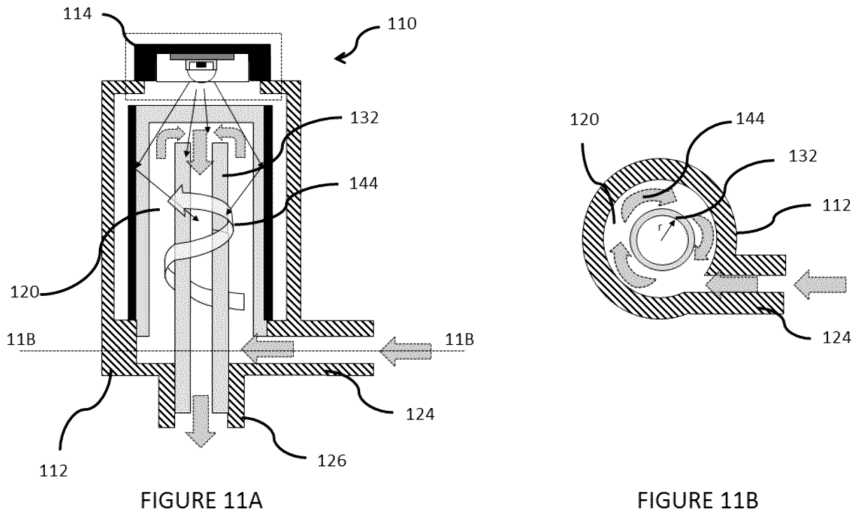

In the fourth embodiment UV LED reactor 110 and depending on the treatment process, the exposure time (t) can be achieved by selection of the length (L) of the reactor chamber 120 and the flow rate of the water flow path 138, 134 through the reactor chamber 120. The required total energy (E) can be achieved by selection of the power of the UV LED module 114. In the fourth embodiment UV LED reactor 110, the water flows from the water inlet 124 and makes a 90 degree turn to flow along the UV transparent inner tube 132 generally parallel to the longitudinal axis 136 in a direction towards the UV LED module 114, and into a UV radiation target area 140. The water in the UV radiation target area 140 then exits the UV radiation target area 140 and flows through the UV transparent inner tube 132 generally parallel to the longitudinal axis 136 of the reactor chamber 120 and away from the UV LED module 114. The water flow path of the fourth embodiment UV LED reactor 110 is termed herein as a “double UV exposure flow path”. As will be further explained, the water flow path of the second embodiment UV LED reactor 110 also includes a “vortex flow path” 144 (FIG. 11). Since the water has at least two distinct flow paths 138, 134, through the reactor chamber 120, the exposure time (t) is at least double the exposure time (t) for the first embodiment UV LED reactor 60, assuming the same water flow rate.

Referring to FIGS. 11A and 11B, further operational characteristics of the fourth embodiment UV LED reactor 110 are illustrated. In particular, the UV transparent inner tube 132, in addition to initiating the previously described “double UV exposure flow path”, can also be configured to initiate a vortex flow path 144. The vortex flow path 144 travels from the water inlet 124 and around and circumjacent to the UV transparent inner tube 132, where it combines with the “double UV exposure flow path”. The UV transparent inner tube 132 is formed with an inside diameter “r” that determines the geometry of the vortex flow path 144. In alternate embodiments, the vortex flow path 144 through the reactor chamber 120 can be reversed from that shown in FIG. 11A, such that the water outlet 126 (FIG. 10) would receive the untreated water 82 (FIG. 3) and the water inlet 124 (FIG. 10) would discharge the treated water 84 (FIG. 3). In addition, as will be further explained, multiple UV transparent inner tubes 132 can be configured to provide multiple vortex flow paths.

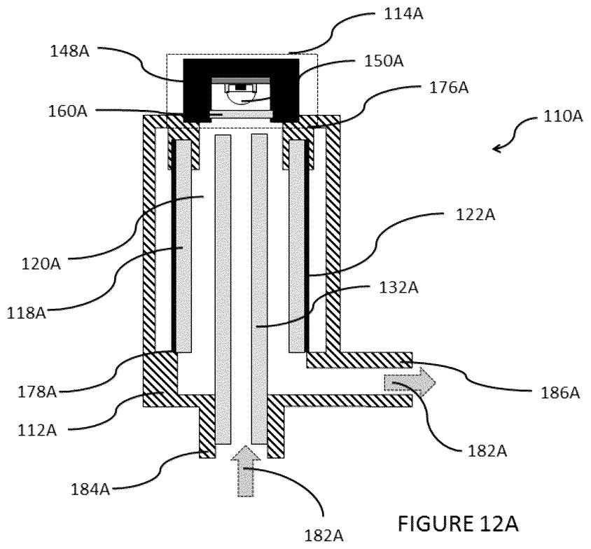

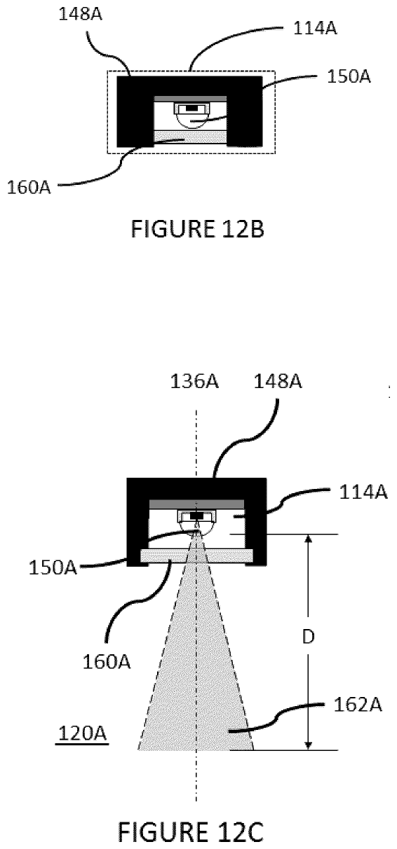

Referring to FIGS. 12A and 12B, a fifth embodiment UV LED reactor 110A includes a UV LED module 114A having a sealed UV transparent window 160A. In the fifth embodiment UV LED reactor 110A, a heatsink 148A of the UV LED module 114A can include a groove for the UV transparent window 160A as well as a sealing system, such as sealants and o-rings operably associated with the UV transparent window 160A and configured to form a fluid tight seal for LED emitters 150A mounted to a sealed cavity within the heatsink 148A. Suitable materials for the sealed UV transparent window 160A include quartz glass and UV transparent polymers.

Still referring to FIGS. 12A and 12B, the UV LED reactor 110A also includes a housing 112A having a hollow cylindrical shape with the reactor chamber 120A having a mounting shelf 178A for mounting a UV transparent outer tube 118A having a UV reflective coating 122A thereon. The UV transparent outer tube 118A also include mounting flanges 176A that attach to the housing 112A permitting easy removal of the UV transparent outer tube 118A for servicing. The UV LED reactor 110A also includes a UV transparent inner tube 132A configured substantially as previously described for UV transparent inner tube 132 (FIG. 4). In the UV LED reactor 110A, a water flow path 182A can be from a water inlet 184A on the housing 112A upward through the UV transparent inner tube 132A towards the UV LED module 114A, then 180 degrees and downward along the UV transparent outer tube 118A, and then 90 degrees to discharge through a water outlet 186A on the housing 112A.

Referring to FIG. 12C, the UV LED reactor 110A also includes LED emitters 150A, which can comprise LED packages, such as packaged vertical light emitting diodes (VLEDs), configured to emit UV radiation 162A having a narrow beam angle that is selected to increase the transmitting distance of the LED emitters 150A within the reactor chamber 120A. The narrow beam angle can be symmetrical to the longitudinal axis 136A of the reactor chamber 120A and can be selected to extend into the reactor chamber 120A by a selected distance (D).

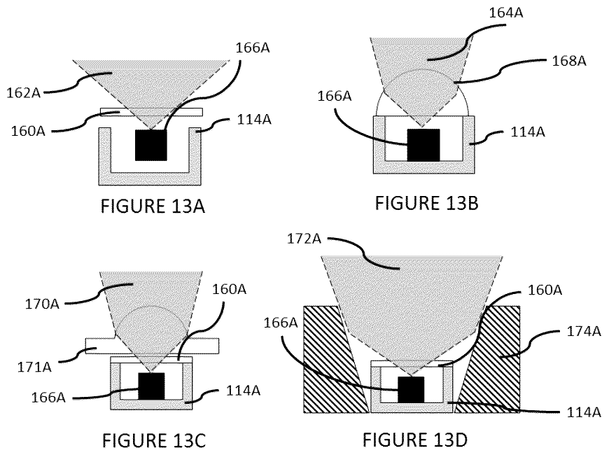

Referring to FIGS. 13A, 13B, 13C and 13D, different methods for manipulating the shape and penetrating distance of the UV radiation emitted by LED emitters 150A are illustrated. FIG. 13A is an enlarged schematic cross sectional view illustrating UV radiation 162A emitted by the UV LED module 114A in the form of a wide light beam formed using a packaged LED die 166A and UV transparent window 160A. FIG. 13B is an enlarged schematic cross sectional view illustrating UV radiation 164A emitted by the UV LED module 114A in the form of a narrow light beam formed using a packaged LED die 166A and an optical lens 168A. FIG. 13C is an enlarged schematic cross sectional view illustrating UV radiation 170A emitted by the UV LED module 114A in the form of a narrow light beam formed using a packaged LED die 166A and a collimated optical lens 171A. FIG. 13D is an enlarged schematic cross sectional view illustrating UV radiation 172A emitted by the UV LED module 114A in the form of a narrow light beam formed using a packaged LED die 166A, a UV transparent window 160A and a reflector 174A.

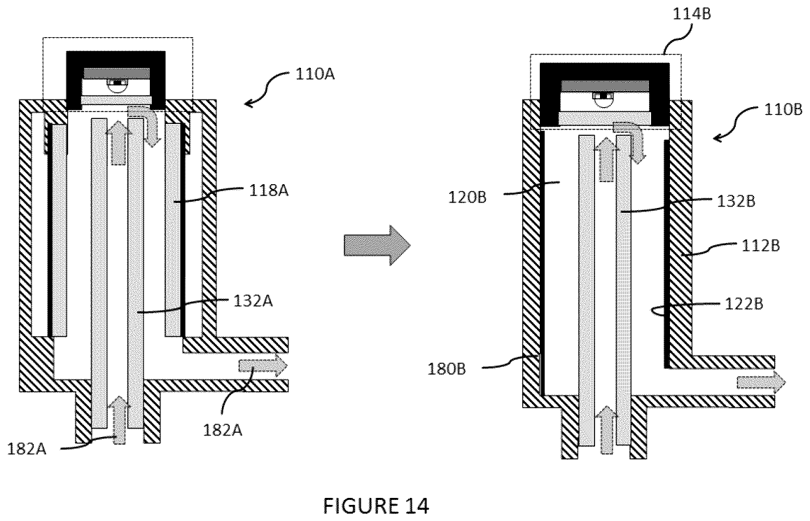

Referring to FIG. 14, a sixth embodiment UV LED reactor 110B, which is shown on the right, is substantially similar to the previously described fifth embodiment UV LED reactor 110A, which is shown on the left. However, in the UV LED reactor 110B, the housing 112B includes a hollow interior portion forming the reactor chamber 120B. In addition, the housing 112B includes interior sidewalls 180B configured to perform the function of the UV transparent outer tube 118A in the previously described UV LED reactor 110A. In the sixth embodiment UV LED reactor 110B, a UV reflective coating 122B can be formed on the interior sidewalls 180B of the housing 112B, which is configured to reflect UV radiation along the entire interior length of the reactor chamber 120B within the housing 112B. The UV reflective coating 122B can comprise a deposited material such as a highly reflective metal (e.g., Al), or curable material such as an acrylic polymer, or a tape material such as a UV reflective tape having a mirror finish. The UV LED reactor 110B also includes a UV transparent inner tube 132B configured substantially as previously described for UV transparent inner tube 132A.

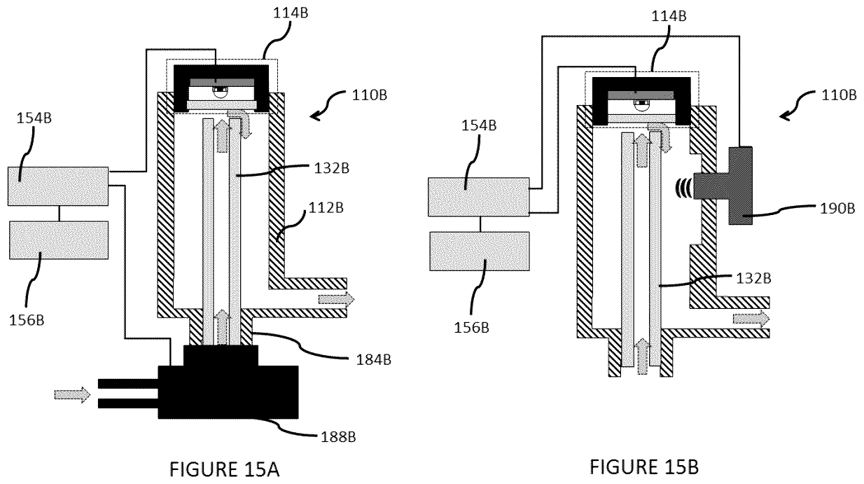

Referring to FIG. 15A, the UV LED reactor 110B (or the previously described UV LED reactors 110 and 110A), can also include a pump 188B in fluid communication with the UV transparent inner tube 132B. The pump 188B can be integrated into the housing 112B and can attach to an inlet 184M on the housing 112B. In addition, a PCB board 154B connected to a power supply 156B can be configured to control the pump 188B and the UV LED module 114B as well. As shown in FIG. 15B, the UV LED reactor 110B (or the previously described UV LED reactors 110 and 110A), can also include a sensor 190B substantially as previously described for sensors 133 (FIG. 8).

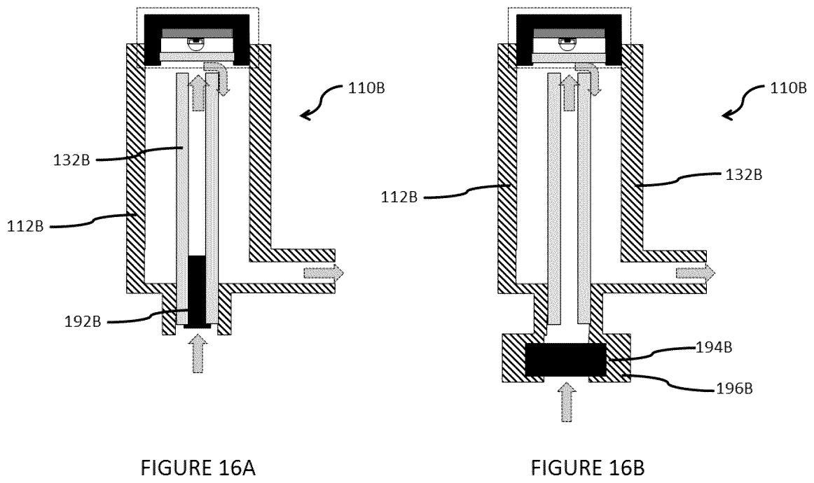

Referring to FIGS. 16A and 16B, the UV LED reactor 110B (or the previously described UV LED reactors 110 and 110A), can also include one or more filters 192B or 194B. In FIG. 16A, the filter 192B is mounted to the UV transparent inner tube 132B. In FIG. 16B, the filter 194B is mounted to a flange 196B on the housing 112B. The filters 192B or 194B can be configured to filter and reduce particulate matter from the water.

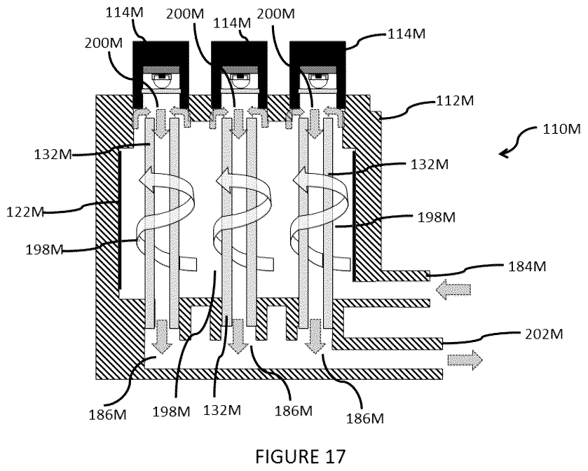

Referring to FIG. 17, a seventh embodiment multi-LED UV LED reactor 110M includes multiple UV LED modules 114M and multiple UV transparent inner tubes 132M configured to generate multiple vortex fluid flows 198M. In the seventh embodiment multi-LED UV LED reactor 110M, each UV LED module 114M includes a UV radiation target area 200M. In addition, water enters through an inlet 184M on the housing 112M and multiple vortex fluid flows 198M are directed towards the UV radiation target areas 200M and then through the UV transparent inner tubes 132M to multiple water outlets 186M on the housing 112M. The housing 112M also includes a converging water outlet 202M which combines the fluid flow from the multiple water outlets 186M. The housing 112M can also include a UV reflective coating 122M, substantially as previously described.

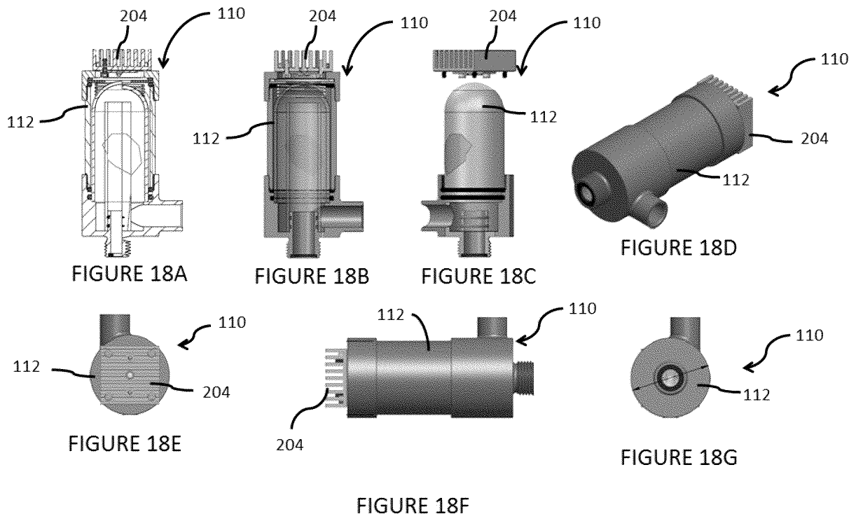

Referring to FIGS. 18A-18G, the housing 112 for the fourth embodiment UV LED reactor 110 is illustrated in different views. FIG. 18A is a schematic cross-sectional view of the housing 112. FIG. 18B is a side elevation view of the housing 112. FIG. 18C is an exploded view of the housing 112. FIG. 18D is a perspective view of the housing 112. FIG. 18E is an end view of the housing 112. FIG. 18F is a side elevation view (FIG. 18F) of the housing 112. FIG. 18G is an end view (FIG. 18G) of the housing 112. As shown in these views, the housing 112 can also include a removeable heat radiator element 204 configured to dissipate heat generated by the UV LED reactor 110.

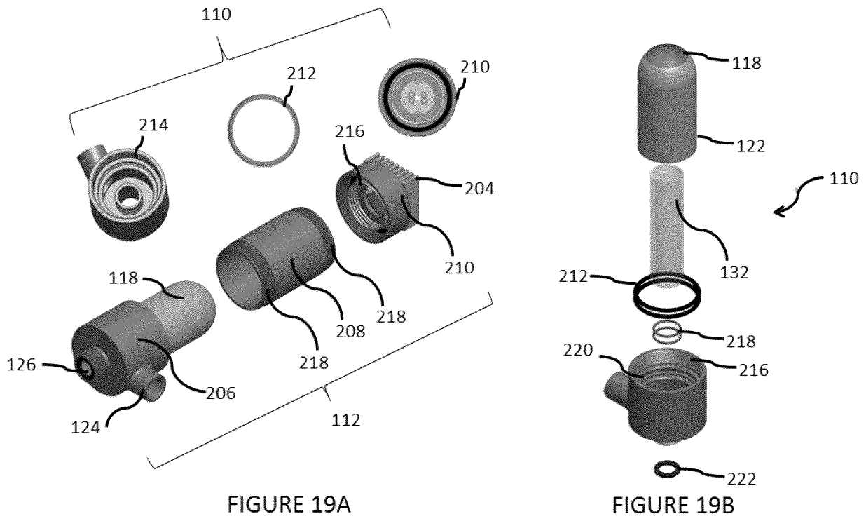

Referring to FIGS. 19A and 19B, the fourth embodiment UV reactor 110 is shown in exploded views. In FIGS. 19A and 19B, some parts have been omitted and some parts have been rotated from the assembly and repeated to show their internal structures. The housing 112 can comprise a nozzle portion 206, a tube portion 208 and a UV core portion 210, that are screwed together to form a unitary watertight assembly. The nozzle portion 206, the tube portion 208 and the UV core portion 210 of the housing 112 can comprise metal or plastic elements formed with desired features in a required size and shape, using suitable processes such as machining, casting, molding, or 3-D printing. The tube portion 208 forms the body of the housing 112 and can comprise a length of tubing threaded on both ends. The nozzle portion 206 can be generally cylindrical in shape and open on one end for mounting the UV transparent outer tube 118. The nozzle portion 206 can also include the water inlet 124, the water outlet 126 and a seal 222 for the water outlet 126. In addition, the UV transparent outer tube 118 can be mounted to the nozzle portion 206 and sealed by o-rings 212 that mate with grooves 214 in the nozzle portion 206. The nozzle portion 206 can also include internal threads 216 that mate with external threads on the tube portion 208 of the housing 112. The UV transparent inner tube 132 also mounts to the nozzle portion 206 of the housing 112 using o-rings 218 that mount to grooves 220 in the nozzle portion 206. The UV core portion 210 of the housing 112 contains the UV LED module 114 and can also include the heat radiator element 204. The UV core portion 210 also includes internal threads 216 that mate with the external threads on the tube portion 208 to form a watertight assembly.

While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope.

What is claimed is:

1. A UV LED reactor configured to perform a treatment process on a fluid comprising:
a housing having an inlet for receiving the fluid, a reactor chamber for treating the fluid, and an outlet for discharging the fluid; and
a UV LED module mounted to the housing comprising:
a base;
a UV LED emitter on the base configured to emit UV radiation having a selected wavelength range, a selected beam angle and a selected energy into a radiation target area in the reactor chamber;
a heatsink on the base having a surface in thermal communication with the fluid in the reactor chamber configured to dissipate heat generated by the UV LED emitter into the fluid; and
a UV transparent window mounted to the heatsink configured to provide a planar emitting surface for the UV LED emitter to emit the UV radiation into the radiation target area of the reactor chamber.

2. The UV LED reactor of claim 1 wherein the heatsink comprises a metal, a polymer or a ceramic having a thermal conductivity coefficient greater than 20 W/mK.

3. The UV LED reactor of claim 1 wherein the heatsink comprises a single piece of material.

4. The UV LED reactor of claim 1 wherein the heatsink comprises a plurality of cooling fins or one or more surfaces having an increased surface area.

5. The UV LED reactor of claim 1 further comprising a UV transparent inner tube mounted to the housing in proximity to the UV LED module configured to direct the fluid in a flow path from the inlet to the outlet.

6. The UV LED reactor of claim 5 wherein the flow path includes a first direction towards the UV LED module and then a second direction away from the UV LED module, with both the first direction and the second direction generally parallel to a longitudinal axis of the reactor chamber.

7. The UV LED reactor of claim 5 wherein the UV transparent inner tube is configured to impart a vortex flow along the longitudinal axis of the reactor chamber.

8. The UV LED reactor of claim 1 wherein the fluid comprises water, the selected wavelength range is 180 nm to 430 nm, and the treatment process comprises sterilization of the water.

9. The UV LED reactor of claim 1 wherein the selected beam angle is symmetrical with respect to a longitudinal axis of the reactor chamber.

10. The UV LED reactor of claim 1 wherein the LED emitter comprises a packaged LED die having a collimated optical lens.

11. The UV LED reactor of claim 1 wherein the base of the UV LED module includes a printed circuit board.

12. The UV LED reactor of claim 1 further comprising a temperature sensor integrated into the UV LED module configured to sense a temperature of the heatsink and a switch integrated into the UV LED module in electrical communication with the sensor configured to turn off or control power to the UV LED emitter as a function of the temperature.

13. The UV LED reactor of claim 1 further comprising a parameter sensor on the housing within the reactor chamber configured to sense a parameter of the fluid in the reactor chamber.

14. The UV LED reactor of claim 1 wherein the housing comprises a cylindrical tube and the UV LED module comprises a first UV LED module mounted to a first end of the cylindrical tube and a second UV LED module mounted to a second end of the cylindrical tube.

15. The UV LED reactor of claim 1 further comprising a UV reflective coating within the reactor chamber configured to direct reflected radiation onto the fluid in the reactor chamber.

16. The UV LED reactor of claim 15 wherein the UV reflective coating is on a surface of a tube or sleeve mounted to the housing.

17. The UV LED reactor of claim 1 wherein the UV LED module includes a mechanical connector configured to mount the UV LED module to the housing with the heatsink within the reactor chamber.

18. A UV LED reactor configured to perform a treatment process on a fluid comprising:
a housing having an inlet for receiving the fluid, a reactor chamber for treating the fluid, and an outlet for discharging the fluid;
a UV LED module mounted to the housing comprising:
a base;
a UV LED emitter on the base configured to emit UV radiation having a selected wavelength range, a selected beam angle and a selected energy into the reactor chamber, and
a heatsink in thermal communication with the base configured to dissipate heat generated by the UV LED emitter having a surface in contact with the fluid in the reactor chamber configured to dissipate heat generated by the UV LED emitter into the fluid; and
a UV transparent inner tube mounted to the inlet in flow communication with the outlet configured to direct a fluid flow path in a first direction towards the UV LED module and then in a second direction away from the UV LED module.

19. The UV LED reactor of claim 18 further comprising a UV transparent tube mounted to the housing in proximity to the UV LED module, and a UV reflective coating covering a surface of the UV transparent tube configured to direct reflected UV radiation into the reactor chamber.

20. The UV LED reactor of claim 18 wherein the first direction and the second direction are generally parallel to a longitudinal axis of the reactor chamber, such that the fluid flow path comprises a double UV exposure flow path.

21. The UV LED reactor of claim 18 wherein the UV transparent inner tube is configured to impart a vortex flow along the longitudinal axis of the reactor chamber.

22. The UV LED reactor of claim 18 wherein the UV LED module includes a plurality of UV LED modules and the UV transparent inner tube comprises a plurality of UV transparent inner tubes configured to generate multiple vortex fluid flows towards the UV LED modules.

23. The UV LED reactor of claim 18 wherein the fluid comprises water and the treatment process comprises sterilization of the water.

24. The UV LED reactor of claim 18 wherein the selected wavelength range is 180 nm to 430 nm.

25. The UV LED reactor of claim 18 wherein the UV LED module includes a UV transparent window mounted to the heatsink configured to provide a planar emitting surface for the UV LED module.

26. The UV LED reactor of claim 18 wherein the UV LED module includes a reflector configured to provide the beam angle.

27. The UV LED reactor of claim 18 further comprising a temperature sensor integrated into the UV LED module configured to sense a temperature of the heatsink and a switch integrated into the UV LED module in electrical communication with the sensor configured to turn off or control power to the UV LED emitter as a function of the temperature.

28. A UV LED reactor configured to perform a treatment process on a fluid comprising:
a housing having an inlet for receiving the fluid, a reactor chamber for treating the fluid, and an outlet for discharging the fluid; and
a UV LED module mounted to the housing comprising:
a base;
a UV LED emitter on the base configured to emit UV radiation having a selected wavelength range, a selected beam angle and a selected energy into the reactor chamber, and
a heatsink in contact with the base configured to dissipate heat generated by the UV LED emitter having a surface in contact with the fluid in the reactor chamber configured to dissipate heat into the fluid.
a UV reflective coating on the housing in the reactor chamber; and
a UV transparent inner tube mounted to the housing configured to direct a fluid flow in a first direction towards the UV LED module and then in a second direction away from the UV LED module;
the UV transparent tube and the UV reflective coating configured such that the fluid in the reactor chamber is exposed to direct UV radiation from the UV LED module, and to reflected UV radiation along a length of the reactor chamber, which has been reflected from the reflective coating on the housing back into the reactor chamber.

29. The UV LED reactor of claim 28 wherein the UV reflective coating is formed on sidewalls of the housing.

30. The UV LED reactor of claim 28 wherein the UV reflective coating is formed on an outer tube mounted to the housing within the reactor chamber.

31. The UV LED reactor of claim 28 wherein the heatsink comprises a plurality of cooling fins.

32. The UV LED reactor of claim 28 wherein the surface of the heatsink comprises a cooling fin.

33. The UV LED reactor of claim 28 wherein the first direction and the second direction are generally parallel to a longitudinal axis of the reactor chamber, such that the fluid flow path comprises a double UV exposure flow path.

34. The UV LED reactor of claim 28 wherein the UV transparent inner tube is configured to impart a vortex flow along a longitudinal axis of the reactor chamber.

35. The UV LED reactor of claim 28 wherein the selected beam angle is symmetrical with respect to a longitudinal axis of the reactor chamber.

36. The UV LED reactor of claim 28 wherein the fluid comprises water and the treatment process comprises sterilization of the water.

37. The UV LED reactor of claim 28 wherein the selected wavelength range is 180 nm to 430 nm.

38. The UV LED reactor of claim 28 wherein the UV LED module includes a UV transparent window mounted to the heatsink configured to provide a planar emitting surface for the UV LED module.

39. The UV LED reactor of claim 28 further comprising a temperature sensor integrated into the UV LED module configured to sense a temperature of the heatsink and a switch integrated into the UV LED module in electrical communication with the sensor configured to turn off or control power to the UV LED emitter as a function of the temperature.

40. The UV LED reactor of claim 28 further comprising a parameter sensor on the housing within the reactor chamber configured to sense a parameter of the fluid in the reactor chamber.

41. The UV LED reactor of claim 28 wherein the base comprises a printed circuit board having a controller.
